(19) United States
(12) Patent Application Publication
(10) Pub. No.: US 2004/0197362 A1
(43) Pub. Date: Oct. 7, 2004

(54) BUGNIP

(76) Inventor: Cassandra Marie Wagner, Winder, GA (US)

Correspondence Address: Cassandra Marie Wagner, 125 Sportsman Road, Rotunda West, FL, 33947, US

(21) Appl. No.: 10/406,142

(22) Filed: Apr. 4, 2003

(51) Int. Cl. A01N 25/00

(52) U.S. Cl. 424/405

(57) ABSTRACT

The purpose of my invention is to find a more effective insect repellent that is safe for the environment and people. Catnip is an herb that was once used for medicinal purposes such as colic in babies, and skin irritations. Lemon juice is found in most refrigerators across the country. This is the combination I have used to develop my insect repellent, BUGNIP. DEET, the most common insect repellent, can have serious adverse side effects from overuse, and use on small children. BUGNIP is made from ingredients that have been used medicinally through the centuries, and will not have adverse side effects. This is especially important today, while West Nile is a threat. People are concerned about the adverse effects of chemically based repellents, and do not want to use them. This is where my invention, BUGNIP, is different from other repellents. It is safe, and it repels insects.

### CROSS REFERENCE TO RELATED APPLICATIONS

There are no related applications.

### FEDERAL RESEARCH STATEMENT

There are no rights to this invention made under federally sponsored research and development.

### REFERENCE TO SEQUENCE LISTING, ECT

There are no sequence listing, tables, or compact disk appendix.

### BACKGROUND OF INVENTION

BUGNIP is a homeopathic insect repellent developed for human and environmental control of insects. It repels and inhibits insects without chemicals.

### BRIEF SUMMARY OF INVENTION

This invention is a non chemical insect repellent that is safe for the environment and humans. This is a homeopathic (non chemical) insect repellent, safe for both. The object of this invention is to provide an alternative repellent to those that contain chemicals, which may have adverse side effects. This invention has a repellency against mosquitos, gnats, fleas, spiders, and so forth.

### DRAWINGS

There are no drawings.

### DETAILED DESCRIPTION

The invention, BUGNIP, is a homeopathic insect repellent, meaning it is made from all natural ingredients. It is safe for the environment and people. The repellent consists of 14.85% nepetelactone oil, extracted from catnip, 13.67% pure lemon juice, and 71.48% water.

Nepetalactone oil was isolated from dried organic catnip using a coffee pot and coffee filter. 250 ml of catnip leaves are placed in the filter section of the coffee pot, and 250 ml of water is placed in the water section. The coffee pot is turned on to run one full cycle. After allowing it to cool for 15 minutes, 23 ml of pure lemon juice is added. The invention is then funneled into a bottle with a spray mist lid, and sealed.

To apply, the invention was sprayed a determined number of times per square meters.

To test for repellency, environmental experiments were used. In one, the invention was applied in an area known for mosquitoes, gnats, spiders, fleas, and other insects. The target area was then observed for the amount of time the insects spent in the area with the invention. 97% of the insects were repelled in this experiment, which was conducted 40 times.

In another experiment, shadow boxes with a laminate were made. The repellent was applied to the boxes and surrounding area. The target area was observed for the amount of time insects remained in the area, and how many actually went into the box. In this experiment, 97% of the insects were repelled. This experiment was also repeated 40 times.

What is claimed is:

1. A repellent composition comprising of 14.85% nepetalactone, 13.67% lemon juice, and 71.48% water will repel a pest from a target area.

2. The composition of claim one is a liquid.

3. The composition of claim one where the target area is indoors or outdoors.

4. The composition of claim one where the pest is a mosquito, gnat, flea, spider.

5. The composition of claim one where the nepetalactone is derived from pure organic dried catnip through steam distillation.

6. The composition of claim one where the target area is selected from a garden, plant, screen, shipping container, door frame, cupboard, and carpet.

7. The method of application of the composition in claim one is a fine mist spray bottle.

8. This repellent is biogenic.

9. The composition of claim eight where it is safe for the environment.

10. The composition of claim eight where it is safe for animal and humans.

11. This repellent is more effective than chemically based repellents available on the market today.

12. The composition of claim eleven where the chemically based repellent is DEET.
